(19) United States
(12) Patent Application Publication
(10) Pub. No.: US 2019/0103781 A1
(43) Pub. Date: Apr. 4, 2019

(54) MOTOR

(71) Applicant: NIDEC SERVO CORPORATION, Kiryu-shi (JP)

(72) Inventor: Norihisa IMAIZUMI, Kiryu-shi (JP)

(21) Appl. No.: 16/133,733

(22) Filed: Sep. 18, 2018

(30) Foreign Application Priority Data
Sep. 29, 2017 (JP) 2017-191305

(51) Int. Cl. H02K 3/32; H02K 1/14; H02K 1/27; H02K 1/28; H02K 3/18

(52) U.S. Cl. CPC H02K 3/325; H02K 1/146; H02K 1/2786; B64C 39/024; H02K 3/18; H02K 2203/12; H02K 1/28

(57) ABSTRACT

A motor includes a rotor that rotates about a central axis and a stator that opposes the rotor in a radial direction. The stator includes a stator core with a core back, which has an annular shape, and teeth extending in the radial direction from the core back, bobbins each attached to a corresponding one of the teeth, and coil wires wound around the bobbins. The stator includes winding groups in which one coil wire is wound around the bobbins, and a number of poles of the rotor and a number of slots of the stator are 10 poles and 12 slots, 28 poles and 24 slots, 42 poles and 36 slots, or 44 poles and 33 slots.

### CROSS REFERENCE TO RELATED APPLICATIONS

This application claims the benefit of priority to Japanese Patent Application No. 2017-191305 filed on Sep. 29, 2017. The entire contents of this application are hereby incorporated herein by reference.

### BACKGROUND OF THE INVENTION

### 1. Field of the Invention

The present disclosure relates to a motor.

### 2. Description of the Related Art

To date, a stator coil is known in which one coil wire is wound around a plurality of bobbins in order to reduce the number of coil end connections.

However, in the existing motor, when a plurality of bobbins wound with a single coil wire are arranged continuously in the circumferential direction, in some cases vibration may increase depending on the number of slots of the stator.

### SUMMARY OF THE INVENTION

According to one aspect of exemplary embodiments of the present disclosure, a motor includes a rotor that rotates about a central axis, and a stator that opposes the rotor in a radial direction. The stator includes a stator core including a core back, which has an annular shape, and a plurality of teeth extending in the radial direction from the core back, a plurality of bobbins each attached to a corresponding one of the teeth, and coil wires wound around the bobbins. The stator includes a plurality of winding groups in which one coil wire is wound around the bobbins, and, in the winding groups, the numbers of poles of the rotor and the numbers of slots of the stator are 10 poles and 12 slots, 28 poles and 24 slots, 42 poles and 36 slots, or 44 poles and 33 slots.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a motor according to an exemplary embodiment of the present invention as viewed from above.

FIG. 2 is a perspective view of the motor according to an exemplary embodiment of the present invention as viewed from below.

FIG. 3 is a cross-sectional view illustrating a motor according to an exemplary embodiment of the present invention.

FIG. 4 is a perspective view illustrating a winding group.

FIG. 5 is a winding diagram of one winding group.

FIG. 6 is a plan view of a stator.

### DETAILED DESCRIPTION OF THE PREFERRED EMBODIMENTS

Exemplary embodiments of the present disclosure will be described below with reference to the drawings.

Further, in the present application, the direction parallel to a rotation axis J of a shaft 21 of a motor 11 is referred to as “the axial direction”, the direction perpendicular to the rotation axis J is referred to as “the radial direction”, and the direction along an arc with the rotation axis J as the center is referred to as “the circumferential direction”. In addition, in the present application, the shape and positional relationship of each element will be described with the axial direction taken as the up-down direction and with one side in the axial direction, which is a stator 30 side with respect to a base portion 40, being defined as the upper side. That is, one direction in which the rotation axis J extends is defined as the up-down direction. However, in practicality, the definition of the up-down direction does not aim to limit the orientation of the motor according to the present disclosure.

In addition, in the present application, the “parallel direction” also includes a substantially parallel direction. In addition, in the present application, the “perpendicular direction” also includes a direction that is substantially perpendicular.

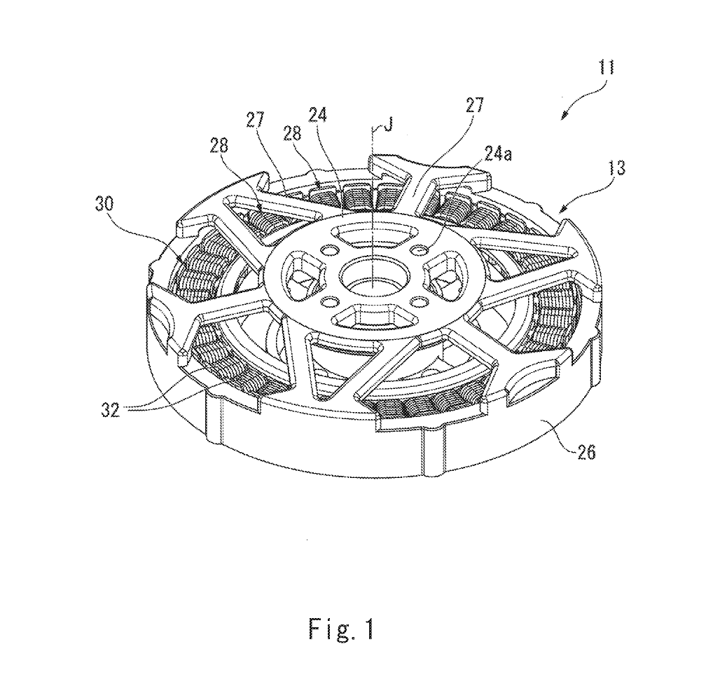

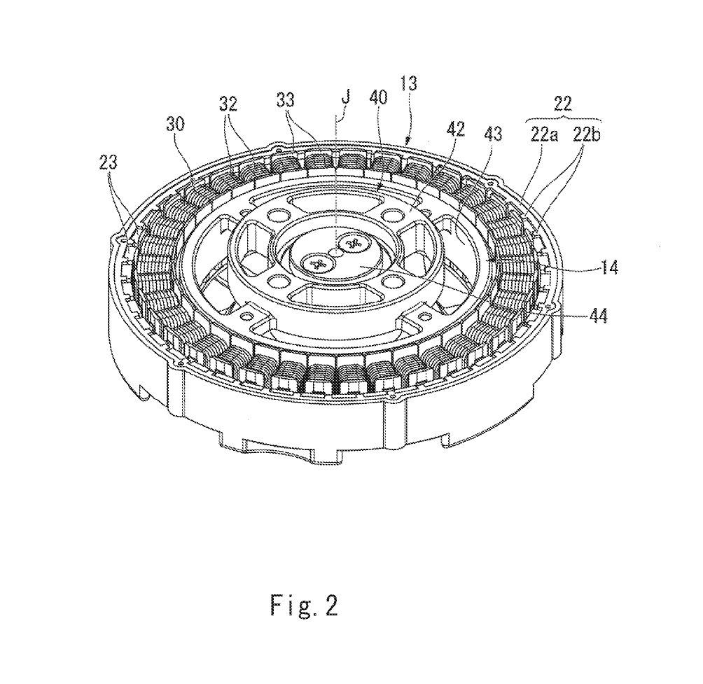

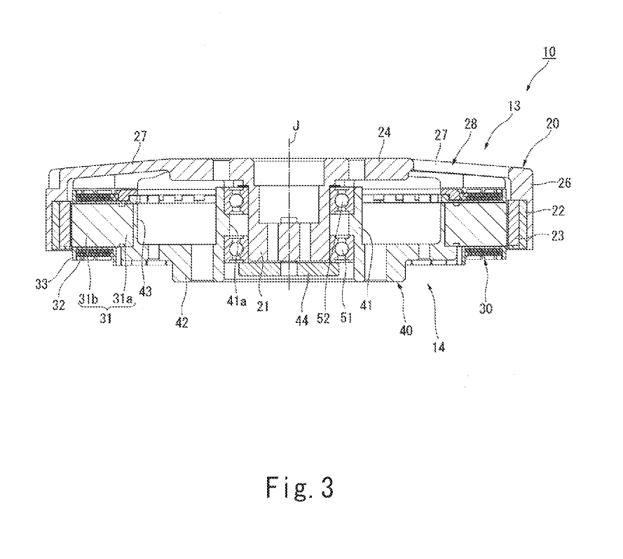

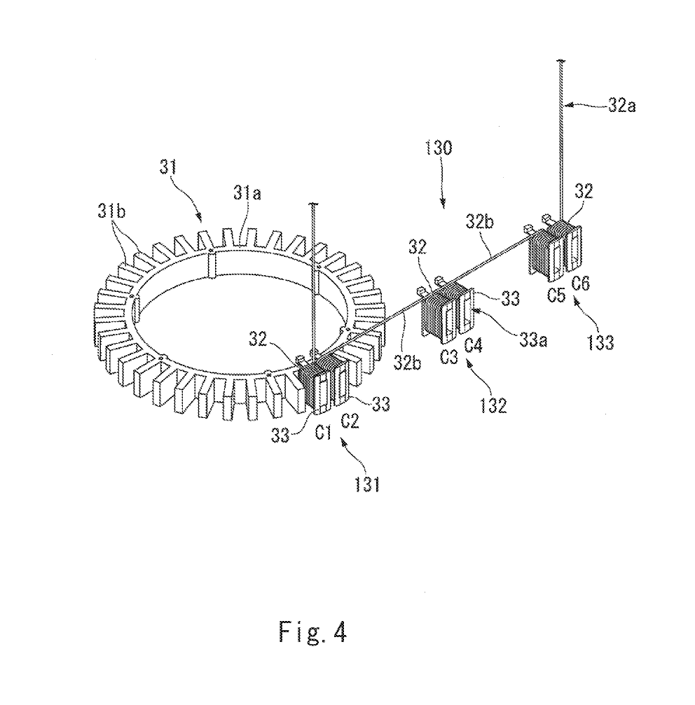

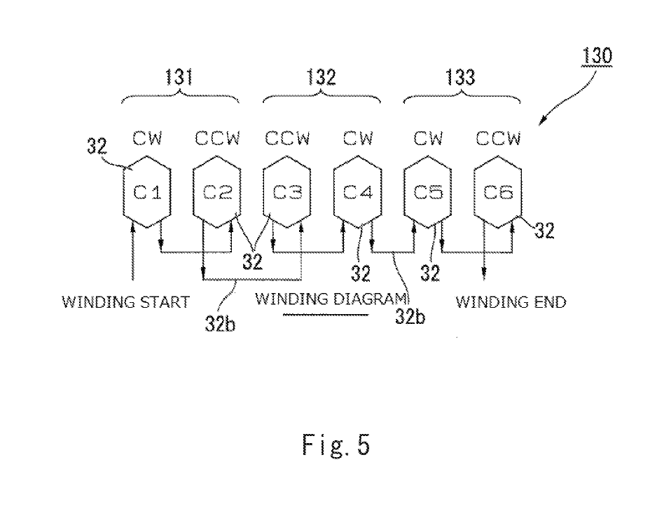

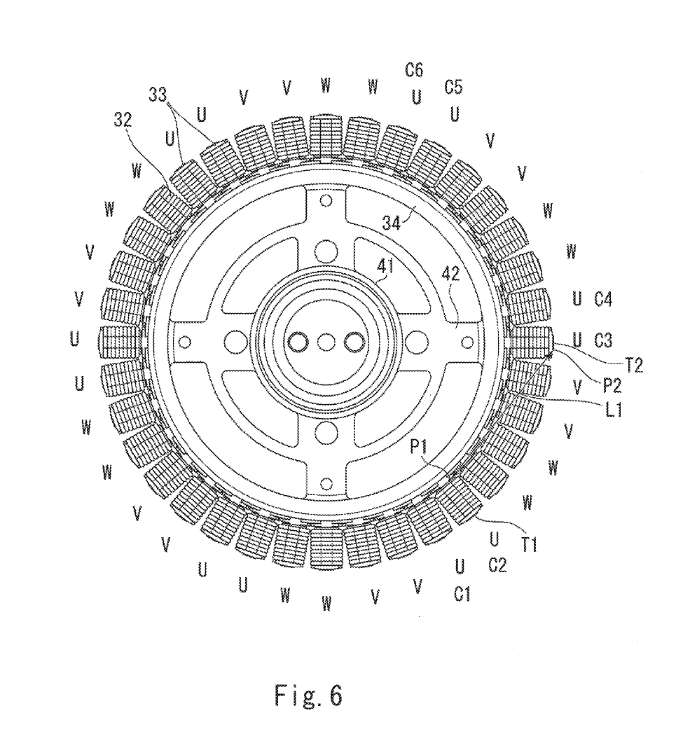

FIG. 1 is a perspective view of the motor according to the present embodiment as viewed from above. FIG. 2 is a perspective view of the motor according to the present embodiment as viewed from below. FIG. 3 is a cross-sectional view illustrating the motor according to the present embodiment. FIG. 4 is a perspective view illustrating a winding group. FIG. 5 is a winding diagram of one winding group. FIG. 6 is a plan view of a stator.

The motor 11 of the present embodiment is used as, for example, a motor that rotates rotor blades in a multi-copter. Hereinafter, the motor 11 of the present embodiment that is to be mounted in a multi-copter will be described; however, the application of the motor 11 is not limited to a multi-copter.

As illustrated in FIG. 1 and FIG. 2, the motor 11 of the present embodiment is an outer rotor type motor. The motor 11 includes a rotor 13 to which rotor blades are fixed and a stationary portion 14 that is to be attached to a multi-copter. As illustrated in FIG. 3, the rotor 13 and the stationary portion 14 are connected via bearing portions 51 and 52 that support the rotor 13 so as to be rotatable. The rotor 13 is an element that rotates in the circumferential direction with the rotation axis J as the center thereof.

The rotor 13 has the shaft 21, a rotor main body 20, magnets 23, and a yoke 22. The shaft 21 extends in the axial direction with the rotation axis J as the center thereof. The shaft 21 is supported by the bearing portions 51 and 52 so as to be rotatable. The bearing portions 51 and 52 are ball bearings each formed of an inner ring, an outer ring, balls, and a retainer. Further, the bearing portions 51 and 52 may be sliding bearings. The shaft 21 is inserted into a base through hole 41a of the base portion 40 (described later) and inserted into the inner rings of the bearing portions 51 and 52.

The rotor main body 20 is connected to the upper end of the shaft 21. The rotor main body 20 extends from the upper end of the shaft 21 along the upper surface of the stator 30 to the outer peripheral surface of the stator 30. The rotor main body 20 includes a rotor disc portion 24 extending from the upper end of the shaft 21 in a direction perpendicular to the rotation axis J, a plurality of rotor rib portions 27 extending outward in the radial direction from the outer peripheral end of the rotor disc portion 24, and a rotor outer edge portion 26 that has a substantially cylindrical shape extending downward in the axial direction from the outer end of the rotor rib portions 27. In the case of the present embodiment, the shaft 21 and the rotor main body 20 are a single member.

The rotor disc portion 24 has a plurality of rotating member fixing portions 24a to which the rotor blades are fixed. In the present embodiment, the rotating member fixing portions 24a are through holes that penetrate the rotor disc portion 24 in the axial direction. Internal threads are provided on the inner peripheral surfaces of the rotating member fixing portions 24a. The rotor blades are fixed to the rotor main body 20 by screws tightened to the rotating member fixing portions 24a. The rotor blades may be fixed to the rotor main body 20 by a method other than screws, such as bonding or caulking.

The rotor rib portions 27 extend radially outward from the outer peripheral end of the rotor disc portion 24. The rotor rib portions 27 connect the rotor disc portion 24 and the rotor outer edge portion 26 to each other. As illustrated in FIG. 1, the rotor rib portions 27 are bar-like portions extending in the radial direction. The rotor rib portions 27 extend to the upper end surface of the rotor outer edge portion 26. The plurality of rotor rib portions 27 are, for example, arranged at unequal intervals along the circumferential direction. For example, six rotor rib portions 27 are provided.

As a result of connecting the rotor disc portion 24 and the rotor outer edge portion 26 with the plurality of the rotor rib portions 27, the rotor main body 20 has rotor hole portions 28 between the rotor rib portions 27 in the circumferential direction. The rotor hole portions 28 are holes penetrating the rotor main body 20 in the axial direction. For example, six rotor hole portions 28 are provided.

Because the rotor main body 20 has the rotor hole portions 28, air circulation paths to the inside of the motor 11, that is, the stator 30, are formed, and the stator 30 can be cooled when the motor 11 is driven. In the present embodiment, the rotor hole portions 28 open above the stator 30 and the outside air directly impinges against coils 32. As a result, the heated coil wire can be efficiently cooled.

As illustrated in FIG. 2, the yoke 22 is a substantially cylindrical member with the rotation axis J as the center. The yoke 22 is disposed on the inner peripheral surface of the rotor outer edge portion 26. The yoke 22 is composed of a ferromagnetic material. The yoke 22 covers at least a portion of the outer peripheral surface of the magnets 23. As a result, leakage of magnetic force from the outer peripheral surface of the magnets 23 is suppressed.

The yoke 22 has a yoke cylindrical portion 22a, which has an annular shape, with the rotation axis J as the center and a plurality of yoke protruding portions 22b protruding inward in the radial direction from the inner peripheral surface of the yoke cylindrical portion 22a. The yoke cylindrical portion 22a is disposed outward of the stator 30 in the radial direction. The plurality of the yoke protruding portions 22b are arranged at substantially equal intervals in the circumferential direction.

The magnets 23 have a rectangular plate shape that is elongated in the axial direction. In this embodiment, a plurality of the magnets 23 are provided. In the present embodiment, 42 magnets 23 are provided. The magnets 23 are fixed to the inner peripheral surface of the yoke 22 by, for example, an adhesive. More specifically, the plurality of the magnets 23 are fixed to portions sandwiched by two yoke protruding portions 22b adjacent to each other in the circumferential direction on a surface of the yoke cylindrical portion 22a facing inward in the radial direction. The magnets 23 have magnetic N poles and S poles on the inner peripheral surface thereof. The magnets 23 having the magnetic N poles and the magnets 23 having the magnetic S poles are arranged alternately along the circumferential direction.

As illustrated in FIGS. 2 and 3, the inner circumferential surface of the magnets 23 opposes an outer end surface of a plurality of teeth 31b (to be described later) in the radial direction with a slight gap therebetween. That is, the magnets 23 have magnetic pole surfaces that oppose the stator 30 in the radial direction. Further, a magnet having a substantially cylindrical shape surrounding the entire outer peripheral surface of the stator 30 may be used. In this case, N poles and S poles are alternately magnetized in the circumferential direction on the inner peripheral surface of the magnet.

The stationary portion 14 includes the base portion 40 and the stator 30. As illustrated in FIG. 2 and FIG. 3, the base portion 40 includes a base cylindrical portion 41 extending in the axial direction with the rotation axis J as the center thereof, a base bottom portion 42 extending outward from the lower end portion of the base cylindrical portion 41 in the radial direction, and a stator-supporting cylindrical portion 43, which is cylindrical, extending upward in the axial direction from an outer end portion of the base bottom portion 42 in the radial direction.

A stator core 31 (to be described later) of the stator is fixed to the outer peripheral surface of the stator-supporting cylindrical portion 43.

The base cylindrical portion 41 has the base through hole 41a penetrating the base cylindrical portion 41 in the axial direction with the rotation axis J as the center thereof. The bearing portions 51 and 52 are arranged inside the base through hole 41a.

The two bearing portions 51 and 52 are arranged side by side in the axial direction inside the base through hole 41a. A lid portion 44 presses the bearing portion 51 from the lower side. The bearing portions 51 and 52 are fixed to the shaft 21 and the base portion 40 thereby supporting the rotor 13 so as to be rotatable with the rotation axis J as the center.

As illustrated in FIG. 3, the stator 30 opposes the rotor 13 in the radial direction with a gap therebetween. As illustrated in FIG. 3 and FIG. 6, the stator 30 is an armature having the stator core 31 and a plurality of the coils 32 to which an electric current is supplied. That is, the stationary portion 14 has a plurality of the coils 32.

The stator core 31 is a magnetic body. The stator core 31 of the present embodiment is formed of a laminated steel plate formed by laminating electromagnetic steel plates in the axial direction. The stator core 31 is fixed to the base portion 40. The stator core 31 has a core back 31a and a plurality of the teeth 31b. The core back 31a has an annular shape with the rotation axis J as the center thereof. The plurality of the teeth 31b extend outward in the radial direction from the core back 31a. The plurality of the teeth 31b are arranged at substantially equal intervals in the circumferential direction. The coils 32 are formed of a conductive wire wound around each of the teeth 31b.

In the present embodiment, as illustrated in FIG. 4, the teeth 31b have a rectangular parallelepiped shape having no umbrella portion at an outer peripheral end thereof. The coils 32 are structures composed of coil wires 32a wound around bobbins 33. The bobbins 33 are rectangular cylindrical members extending in the radial direction and each have a through hole 33a into which a corresponding one of the teeth 31b is inserted. The bobbins 33 are composed of a resin insulating material.

In the stator 30 of the present embodiment, the coils 32 can be attached to and detached from the teeth 31b of the stator core 31 from outside in the radial direction. According to this configuration, because each of the coil wires 32a can be wound around the bobbins 33 in a state where the bobbins 33 are detached from the teeth 31b, the coil wire 32a can be wound around the bobbins 33 at a high density. When the number of slots is large like the stator 30 of the present embodiment, manufacture is facilitated.

The stator 30 is a 36-slot stator having 36 teeth 31b and 36 coils 32. In the present embodiment, as illustrated in FIG. 4, the bobbins 33 attached to the stator core 31 and the coil wire 32a wound around the bobbins 33 form a winding group 130 composed of six bobbins 33 and one coil wire 32a. The stator 30 has six winding groups 130.

The winding group 130 has six coils 32 (coils C1 to C6) composed of one coil wire 32a. The winding group 130 has three bobbin groups 131, 132, and 133 that are each composed of two bobbins 33 attached to adjacent ones of the teeth 31b. The bobbin group 131 and the bobbin group 132 are disposed with a space therebetween in which four bobbins 33 may be disposed. In addition, the bobbin group 132 and the bobbin group 133 are disposed with a space therebetween in which four bobbins 33 may be disposed. Crossover wires 32b composed of the coil wire 32a common to the coils 32 bridge the bobbin group 131 and the bobbin group 132 and the bobbin group 132 and the bobbin group 133. The coil wire 32a drawn from both ends of the winding group 130 is connected to a current control unit, a battery, and the like via a stator wiring portion drawn out of the motor 11.

In each of the bobbin groups 131 to 133, as illustrated in FIG. 5, the winding directions of the two coils 32 around the bobbins 33 are opposite to each other. That is, if the coil C1 is clockwise (CW), the coil C2 wound around the bobbin 33 of the bobbin group 131 becomes counterclockwise (CCW). In the present embodiment, the coil C3 is counterclockwise (CCW) and the coil C4 is clockwise (CW) in the bobbin group 132 that is central. In the bobbin group 133, the coil C5 is clockwise (CW) and the coil C6 is counterclockwise (CCW).

By setting the winding directions of the adjacent ones of the bobbins 33 to be opposite to each other, because the coil wire 32a connecting the adjacent ones of the bobbins 33 passes between the bobbins 33, bending of the coil wire 32a becomes less noticeable. In addition, when attaching the bobbins 33 to the teeth 31b, the crossover wire is not easily bent. Therefore, a good aesthetic appearance can be obtained for the motor 11.

In the present embodiment, as illustrated in FIG. 6, the lengths of the crossover wires connecting the bobbin groups 131 and 132 and the bobbin groups 132 and 133 are equal to the distance L1 from a connection end P1 of a first tooth T1 that connects with the stator core 31 to a tip end P2 of a second tooth T2 that is separated from the first tooth T1 by four teeth 31b.

According to the above configuration, the workability of attaching the bobbins 33 to the teeth 31b is not impaired, and the crossover wires 32b do not excessively bend after installation. This makes it difficult for the crossover wires 32b to protrude from the stator 30 in the axial direction or radial direction. As a result, the insulation of the stator 30 is improved.

As illustrated in FIG. 6, in the stator 30 in which the winding groups 130 are arranged, the coils 32 with a U phase, a V phase and a W phase are periodically arranged two by two. That is, the stator 30 includes two winding groups 130 composed of six U-phase coils, two winding groups 130 composed of six V-phase coils, and two winding groups 130 composed of six W-phase coils. The winding directions of two coils 32 that are adjacent and in-phase are opposite to each other.

In the motor 11 such as that described above, when a driving current is supplied to the coils 32, a magnetic flux is generated in the plurality of the teeth 31b. Then, due to the action of the magnetic flux between the teeth 31b and the magnets 23, circumferential torque is generated between the stator 30 and the rotor 13. As a result, the rotor 13 rotates around the rotation axis J with respect to the stator 30. The rotor blades supported by the rotor 13 rotate together with the rotor 13 around the rotation axis J.

In the stator 30 illustrated in FIG. 6, the coils 32 that are in-phase are dispersed and arranged two by two. In addition, the number of poles of the rotor 13 is 42 poles, and the greatest common divisor with the number of slots 36 is 6. Therefore, in the motor 11, while the toroidal sixth-order electromagnetic excitation force increases, the toroidal second-order electromagnetic excitation force decreases. As a result, at the same timing in the circumferential direction of the rotor 13, the number of positions where deformation occurs is increased and the amount of deformation per position is reduced. As a result, vibration during operation is suppressed.

In the motor 11 of the present embodiment, the crossover wires 32b of the six winding groups 130 of the stator 30 may be disposed on only one surface of the stator 30 on one side or the other side in the axial direction. Because the crossover wires 32b are disposed on only one surface of the stator 30, only the coil wires 32a connected to a connector are arranged on the other surface, the connection of the coil wires 32a to an external device is facilitated, and the aesthetic appearance of the product is improved.

The surface on which the crossover wires 32b are disposed may be a surface of the stator 30 on the side in the axial direction in which the rotor rib portions 27 of the rotor main body 20 are disposed. According to this configuration, because the crossover wires 32b are disposed in the gap that is between the rotor main body 20 and the stator 30 in the axial direction, contact between the crossover wires 32b and an external device can be avoided, and reliability is improved.

The surface on which the crossover wires 32b are disposed may be a surface on the other side of the stator 30 in the axial direction on the opposite side to the rotor rib portions 27 of the rotor main body 20. In the outer rotor type motor, the rotor main body 20 is often arranged on the exposed surface side of the product. By disposing the rotor main body 20 and the crossover wires 32b on different surfaces of the stator 30, the crossover wires 32b cannot be seen in the product appearance and the aesthetic appearance of the motor is improved.

The present disclosure is not limited to the above-described embodiments, and other configurations may be adopted.

Although the motor 11 having 42 poles and 32 slots has been described in the above embodiment, the combination of the number of poles of the rotor 13 and the number of slots of the stator 30 may be 10 poles and 12 slots, 28 poles and 24 slots, or 44 poles and 33 slots.

In the case of a motor with 10 poles and 12 slots, one winding group 130 has a configuration in which one coil wire 32a is wound around four bobbins 33. In this configuration, the bobbins 33 are disposed with a space therebetween in which two bobbins 33 may be disposed. In the winding group 130, the winding directions of the bobbins 33 that are adjacent are opposite to each other.

In the case of a motor with 28 poles and 24 slots, one winding group 130 has a configuration in which one coil wire 32a is wound around four or eight bobbins 33. In this configuration, the bobbins 33 are disposed with a space therebetween in which two bobbins 33 may be disposed. In the winding group 130, the winding directions of the bobbins 33 that are adjacent are opposite to each other.

In the case of a motor with 44 poles and 33 slots, one winding group 130 has a configuration in which one coil wire 32a is wound around eleven bobbins 33. In the winding group 130, the winding directions of the bobbins 33 that are adjacent are opposite to each other.

As described above, by making the combination of the number of poles of the rotor 13 and the number of slots of the stator 30 a specific combination, it is possible to periodically arrange one or two coils 32 in the circumferential direction of the stator 30, and the greatest common divisor of the number of slots can be increased. According to this configuration, because the influence of a toroidal high-order electromagnetic excitation force becomes larger than that in the case where three or more in-phase coils are arranged side by side, the amount of deformation of the rotor 13 and the stator 30 becomes small and vibration is suppressed.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that rotates about a central axis; and
a stator that opposes the rotor in a radial direction; wherein
the stator includes:
a stator core including a core back, which has an annular shape, and a plurality of teeth extending in the radial direction from the core back;
a plurality of bobbins each attached to a corresponding one of the teeth; and
coil wires wound around the bobbins; wherein
the stator includes a plurality of winding groups in which one coil wire is wound around the bobbins; and
numbers of poles of the rotor and numbers of slots of the stator are 10 poles and 12 slots, 28 poles and 24 slots, 42 poles and 36 slots, or 44 poles and 33 slots.

2. The motor according to claim 1, wherein winding directions of the bobbins that are adjacent to each other in each of the winding groups are opposite to each other.

3. The motor according to claim 1, wherein
the number of poles of the rotor and the number of slots of the stator are 42 poles and 36 slots; and
the winding groups each include three bobbin groups each including two of the bobbins attached to adjacent ones of the teeth and disposed at intervals.

4. The motor according to claim 3, wherein the bobbins are detachable in the radial direction from the teeth.

5. The motor according to claim 4, wherein a length of a crossover wire connecting the bobbin groups is equal to a distance from a connection end of a first one of the teeth that connects with the stator core to a tip end of a second one of the teeth separated from the first one of the teeth by four of the teeth.

6. The motor according to claim 1, wherein, in all the winding groups of the stator, crossover wires that connect the bobbins separated by two or more of the teeth are disposed on a surface of the stator on one side in an axial direction.

7. The motor according to claim 6, wherein
the rotor includes a shaft extending along the central axis, a plurality of rotor magnets positioned outside the stator in the radial direction, and a rotor main body portion connected to the shaft and supporting the magnets; and
the rotor main body portion extends from the shaft to an outer peripheral surface of the stator along a surface of the stator on the one side in the axial direction.

8. The motor according to claim 6, wherein
the rotor includes a shaft extending along the central axis, a plurality of rotor magnets positioned outside the stator in the radial direction, and a rotor main body portion connected to the shaft and supporting the magnets; and
the rotor main body portion extends from the shaft to an outer peripheral surface of the stator along a surface of the stator on another side in the axial direction.
